(19) United States
(12) Patent Application Publication
(10) Pub. No.: US 2015/0041554 A1
(43) Pub. Date: Feb. 12, 2015

(54) SOCIAL MEDIA FOUNTAIN

(71) Applicant: Watergush, Inc., Sunnyvale, CA (US)

(72) Inventor: Jose Antonio AGUILERA SANCHEZ, Cupertino, CA (US)

(73) Assignee: Watergush, Inc., Sunnyvale, CA (US)

(21) Appl. No.: 13/960,676

(22) Filed: Aug. 6, 2013

(51) Int. Cl. B05B 17/08; F21V 23/00; H05B 37/02

(52) U.S. Cl. CPC B05B 17/08; H05B 37/0245; F21V 23/003; F21W 2121/02
USPC 239/12; 239/17; 239/18

(57) ABSTRACT

Systems and processes for facilitating control of a decorative water fountain system through a network are described. A central computer may be connected to a network and may communicate with a variety of controllers to drive fountain hardware, lights, and music for an automated performance. Audience members may interact with the fountain system by communicating with the central computer through a network. Users may engage an application on a smartphone to request particular water jets, fountain movements, lights, colors, sounds, or the like. The central computer may receive the requests and communicate corresponding commands to fountain hardware controllers to cause the requested actions to be performed by fountain hardware (e.g., nozzles, lights, motors, pumps, switches, etc.). The central computer may also communicate with online social networks to post information related to user interaction, fountain performances, images, status, or the like.

### BACKGROUND

1. Field

The present disclosure relates generally to decorative water fountains and, more specifically, to network-connected water fountains with social interactivity.

2. Related Art

Decorative water fountains are popular features in both public and private settings around the world. Fountains are frequently installed in parks, city centers, plazas, shopping malls, hotels, and similar locations to enhance public spaces, encourage business patronage, attract tourism, garner tax revenue, appeal to new residents, and the like. Active water features with moving water streams, changing water pressures, and the like are also gaining in popularity, as are more advanced automated water shows with fountains, lights, and sound synchronized in a unified performance.

However, while the attractive and technologically advanced features of decorative water fountains can be very entertaining, such displays typically lack interactivity, and the pre-programmed sequences and performances can stagnate over time without being updated to keep repeat visitors interested. As such, although these displays may attract viewers, they may fail to engage some audiences and may lose impact over time. Accordingly, a system is desired for providing engaging social interactivity to decorative water fountains that may attract wider audiences and provide new and changing content over time.

### SUMMARY

Systems and processes for facilitating control of a fountain system through a network are described. A request for a communication channel for sending fountain performance requests may be received via the network. A request for a fountain hardware performance may be received from the user device through the communication channel. The fountain hardware may be caused to perform the requested performance. The fountain hardware may include one or more water fountains.

The fountain hardware performance request may include a selection of an angle of the one or more water fountains. The user device may generate accelerometer data based on movement, and the selection of the angle of the one or more water fountains may be derived from accelerometer data of the user device. Causing the fountain hardware to perform the requested performance may include causing a motor to angle the one or more water fountains according to the selected angle.

The fountain hardware performance request may include a textual entry from the user device. Causing the fountain hardware to perform the requested performance may include causing a fountain operating characteristic to be changed, such as changing water emission, water volume, lighting color, or nozzle angle. The textual entry may be caused to be uploaded to a website.

The fountain hardware performance request may include a selection of lighting color. Causing the fountain hardware to perform the requested performance may include causing a lighting feature to emit colored light corresponding to the selection. The fountain hardware performance may include a measure of movement of the user device. Causing the fountain hardware to perform the requested performance may include causing the one or more water fountains to emit water at a level corresponding to the measure of movement of the user device.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary system for facilitating control of a water fountain display through a network.

FIG. 2A illustrates an exemplary fountain system.

FIG. 2B illustrates exemplary control software for controlling a water fountain display.

FIG. 3 illustrates an exemplary process for facilitating control of a water fountain display through a network.

FIG. 4 illustrates an exemplary process for establishing user control of a water fountain display from a user device through a network.

FIG. 5A illustrates an exemplary water fountain with direction and flow controls.

FIG. 5B illustrates exemplary fountains with water flow in varied directions.

FIG. 6 illustrates exemplary directional control of a series of fountains.

FIG. 7 illustrates an exemplary fountain interaction where the fountain may respond to entered text and gestures.

FIG. 8 illustrates an exemplary interface for controlling lighting color of a group of fountains.

FIG. 9 illustrates exemplary color control of a group of fountains.

FIG. 10 illustrates an exemplary interface for controlling individual fountains in a group of fountains.

FIG. 11 illustrates an exemplary fountain interaction where the fountain may respond to user device movement.

FIG. 12 illustrates an exemplary fountain interaction where the fountain may respond to movements of a small group of user devices.

FIG. 13 illustrates an exemplary fountain interaction where the fountain may respond to movements of a large group of user devices.

FIG. 14 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

In one embodiment, a decorative water fountain system may be controlled by a central computer that is connected to a network, such as a local area network (LAN), wide area network (WAN), wireless network (Wi-Fi), cellular network, the Internet, or the like. The central computer may communicate with a variety of controllers to drive fountain hardware, lights, and music for an automated performance. Audience members may interact with the fountain system by communicating with the central computer through a network. For example, users can engage an application or “app” on a smartphone to request particular water jets, fountain movements, lights, colors, sounds, or the like. The central computer may receive the requests and communicate corresponding commands to fountain hardware controllers to cause the requested actions to be performed by fountain hardware (e.g., nozzles, lights, motors, pumps, switches, etc.).

In some embodiments, the central computer may also communicate with one or more online social networks to, for example, engage a broader online audience as a form of advertising. For example, the central computer may automatically post information on Twitter™, Facebook™, or other Internet sites. Further, the fountain system may be associated with an entity, account, or profile on Twitter™, Facebook™, or other Internet sites. Such fountain-sourced information can reflect user interaction, fountain performances, images, status, or the like. It should be understood that many other network-enabled and interactive functions are also possible, as will be apparent from the various examples described herein.

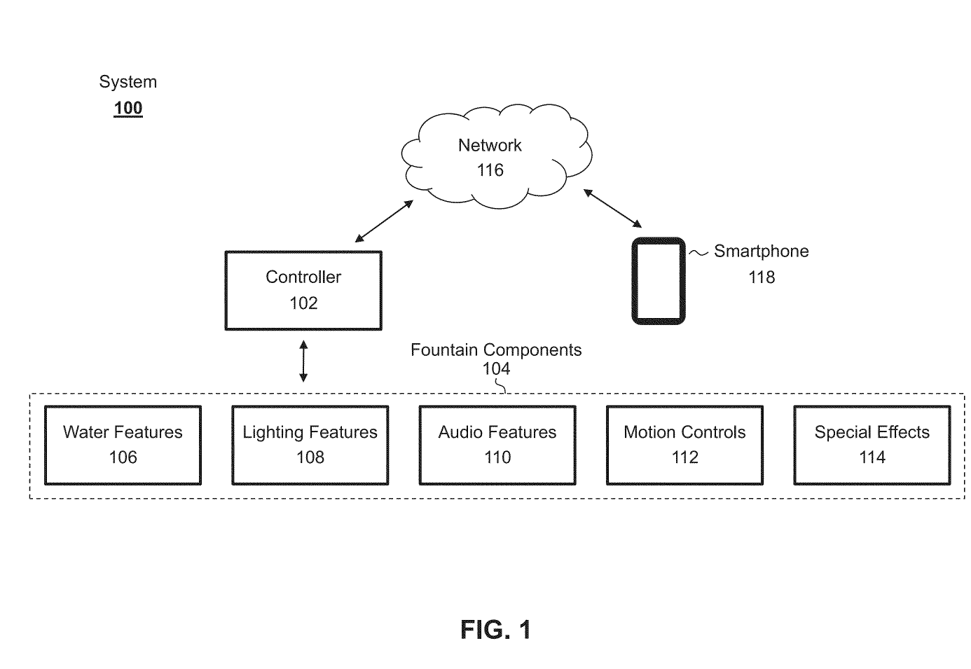

FIG. 1 illustrates exemplary system 100 for facilitating control of water fountain components 104 through network 116. In one embodiment, a user may send fountain performance requests (movement, color, audio, etc.) to controller 102 through network 116 using an application or “app” on smartphone 118. Network 116 may include a local area network (LAN), wide area network (WAN), wireless network (e.g., Wi-Fi), the Internet, or the like. For example, a user standing near a fountain display may use a smartphone to access a wireless network near the fountain and send commands or requests through the wireless network to controller 102. In another example, a user may access the Internet using a desktop computer, tablet computer, smartphone, or the like to send commands or requests through the Internet to controller 102. In other examples, a user may interact with a permanently-installed device at the site of the fountain (e.g., a touch screen, buttons, etc.) or with any of a variety of other devices to send commands or requests to controller 102 across other communication channels (e.g., a data bus, a telephone line, etc.).

Controller 102 may include a server, desktop computer, laptop computer, mobile device, remotely-located server, network controller, programmable logic controller (PLC), microcontroller, Arduino microcontroller, Raspberry Pi single-board computer, or the like. For example, controller 102 may include a computer that functions as an interface between network 116 and fountain components 104. In some embodiments, controller 102 may be located proximate to fountain components 104. In other embodiments, controller 102 may be located at a remote site and may interface with additional controllers, servers, computers, and the like to facilitate user control of fountain components 104. Controller 102 may coordinate the functions of some or all fountain components 104 (described in more detail below) and may synchronize effects to achieve a desired performance or presentation. Controller 102 may likewise include a single controller or may include multiple controllers working in concert. In some examples, controller 102 may cause fountain components 104 to perform in a programmatic or scheduled way. In other examples, controller 102 may receive commands or requests from users and cause fountain components 104 to perform according to the commands or requests dynamically or in real time. In still other examples, controller 102 may allow for both user control and scheduled fountain performances, as desired. By facilitating user control of fountain components 104, system 100 may encourage social interaction with a fountain, which may beneficially attract additional users and enhance the value of the overall fountain installation. It should be understood that many other advantages are possible using system 100 in various applications.

Fountain components 104 may include a variety of devices and elements that make up a decorative water fountain display and that may be controlled by controller 102. In some examples, users may control, through controller 102 and network 116, some or all of fountain components 104 using, for example, smartphone 118. Fountain components 104 can include one or more water features 106, such as fountains, waterfalls, water jets, water streams, sprinklers, and the like, including pumps, motors, controllers, drivers, and the like for recirculating water, pressurizing water, directing water flow, and the like. Water features 106 can include any type of water pump, such as submersible, centrifugal, diaphragm, piston, or the like, and can also include a compressor that functions as a hydro pneumatic system to inject pressurized air into water pipes to give water a potential or kinetic energy that may be modulated by a valve, variable-frequency drive (VFD), or the like to control water emission. Controller 102 or another controller can be electrically connected to water features 106 to control various operations, such as causing water to be emitted during a specific time interval, causing water to be emitted with a specific flow or volume, causing a group of fountains to emit water in sequence, or any of a variety of other water feature functions. For example, controller 102 may be communicatively coupled to VFDs of several water features 106 and may control the height of water emitted from water features 106 by sending commands to the corresponding VFDs. It should be appreciated that various other water features with a variety of functions are possible along with various other control mechanisms for controlling the water feature functions.

Fountain components 104 may also include lighting features 108, such as incandescent light bulbs, light-emitting diodes (LEDs), high-intensity discharge lamps (HIDs), halogen light bulbs, fiber optic lighting, strobe lights, and the like. Lighting features 108 may also include film projectors, television screens, lamps, or a variety of other lighting elements that add to the decorative display. Controller 102 may control lighting features 108 in a variety of ways, including selectively turning lights on or off, modifying light intensity, changing colors, flashing lights, executing a lighting sequence, causing a film to be played, or the like. Controller 102 may also interface with additional controllers that may directly control lighting features, such as circuit interrupters, circuit breakers, solid-state relays (SSRs), triodes for alternating current (TRIACs), and the like. More sophisticated control circuitry may also be included in controller 102 or fountain components 104, such as LED drivers in a multi-channel system that control the intensity of each channel. Similarly, the frequency and intensity of strobe lights can be controlled. In some examples, a protocol for controlling lighting features 108 may be used, such as the digital addressable lighting interface (DALI), digital multiple-X (DMX), or other protocols for addressing and controlling lighting features 108. It should be understood that still other lighting features, functions, and controls are possible in system 100.

Fountain components 104 may also include audio features 110, such as speakers, amplifiers, microphones, and the like. In some examples, audio features can be used to play music that is synchronized with water feature functions (e.g., emitting water in sync with music beats, increasing water volume with louder audio volumes, etc.). In other examples, audio features can be used to create an ambience or environment around the water features. Speakers and other audio features 110 can be arranged in a variety of ways with a variety of effects, such as mono, stereo, 2.1 channel, 5.1 channel, 7.1 channel, or other channel numbers and system arrangements. Audio features 110 may also include a variety of music players or other devices, such as an audio receiver, computer, compact disc player, MP3 player, or the like. In some examples, controller 102 may control which audio track should be played at particular times in coordination with water feature and lighting feature functions. In some instances, controller 102 may also interface with other controllers, drivers, and devices to cause audio to be played. Still other audio features, functions, and controls are possible in system 100.

Fountain components 104 may also include motion controls 112. In some embodiments, water features 106 may include integrated motion controls. In other embodiments, motion controls 112 may be included that can, for example, control the motion of water features, lighting features, audio features, or other system elements. For example, motion controls 112 can include motors or the like that can be connected to various water features to control positioning, spinning, yawing, rolling, pitching, or any other rotational or translational water feature movement. A particular fountain can, for example, be angled back and forth using a motor to cause the emitted water stream to sway back and forth in the air. Various motors can be used, such as open loop motors without feedback and closed loop motors with an incorporated feedback sensor. Various control logic approaches can also be used in motion controls 112, such as a proportional-integral-derivative (PID) controller, fuzzy logic controller, speed controller, or the like. Controller 102 may directly control motion controls 112, or controller 102 may be communicatively coupled to other drivers or controllers that control motion controls 112. It should be appreciated that still other motion control motors, drivers, and the like can be included in system 100 to achieve various water feature and other feature effects.

Fountain components 104 may also include special effects 114. Special effects 114 may include a wide variety of different features to achieve various effects in particular applications. For example, special effects 114 may include fog machines, lasers, fire, fireworks, projectors, or the like. Special effects 114 may include various motors, drivers, igniters, and the like that may be communicatively coupled to controller 102, which may control the various effects as with the other fountain components 104. For example, controller 102 may use a DMX protocol, DALI protocol, circuit interrupters, TRIACs, SSRs, or the like to control special effects 114. It should be appreciated that many other special effects may be included in system 100 along with drivers, motors, and controllers for operating the effects. System 100 may thus facilitate user control and interaction with special effects 114 as well as other fountain components 104 to provide an engaging and entertaining display.

It should be appreciated that some embodiments may not include all of the features illustrated in FIG. 1 as part of system 100, and other embodiments may include additional features that are not illustrated as part of system 100. Similarly, it should be understood that many other approaches for facilitating social interaction with fountain components are possible that are within the scope of this disclosure.

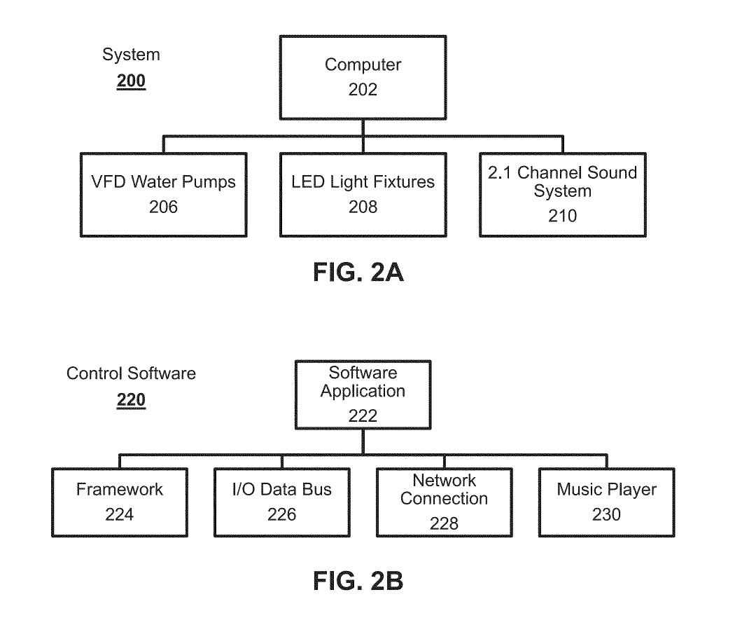

FIG. 2A illustrates exemplary fountain system 200. Fountain system 200 may include similar elements as system 100 of FIG. 1 with specific components included and illustrated as an example implementation of some of the features described with respect to system 100. In particular, system 200 may include computer 202 that may be communicatively coupled to VFD water pumps 206, LED light fixtures 208, and 2.1 channel sound system 210. In one embodiment, system 200 may include, for example, one hundred water features that are individually controlled by one hundred VFD water pumps 206. The water features may be arranged in a variety of different ways, such as in a rectangular matrix (e.g., rows and columns), in concentric circles, in lines, or the like. Each VFD water pump 206 may have a unique address associated therewith in a network or on a data bus, and computer 202 may individually control each VFD water pump 206 by addressing each VFD using the associated unique address on the network or data bus. For example, VFD water pumps 206 may each be assigned a number from zero to ninety-nine, such that each VFD water pump 206 may be individually addressed and controlled by computer 202.

In one example, VFD water pumps 206 may include a controllable resolution of eight bits of data. In particular, VFD pumps 206 may allow for variable flow control that may be based on eight data bits, thereby allowing for over two hundred different levels. The different levels may correspond to water volume, the height of a jet of water, the size of a valve opening, or the like, which allows computer 202 to finely control the effect of each water feature (and the overall effect of the combined display) by addressing a particular VFD pump 206 and commanding a particular level with an eight-bit value.

System 200 may also include one hundred LED light fixtures 208, which may correspond on a one-to-one basis to the one hundred water features. For example, each water feature may have a corresponding LED light fixture 208 that may illuminate the water emitted from the water feature. Like VFD water pumps 206, each LED light fixture 208 may have a unique address associated therewith in a network or on a data bus, and computer 202 may individually control each LED light fixture 208 by addressing each fixture using the associated unique address on the network or data bus. For example, LED light fixtures 208 may each be assigned a number from zero to ninety-nine, such that each LED light fixture 208 may be individually addressed and controlled by computer 202.

LED light fixtures 208 may each include multiple LEDs in multiple colors. For example, an LED light fixture 208 may include multiple red LEDs, multiple green LEDs, and multiple blue LEDs, which together can generate multiple colors using red-green-blue (RGB) combinations. In one example, LED light fixtures 208 may include a controllable resolution of twenty-four bits of data. In particular, LED light fixtures 208 may allow for different light combinations based on twenty-four data bits, thereby allowing for over sixteen million color combinations. The different color combinations may correspond to a large spectrum of colored light with varied brightness and intensity ranging from various dark hues to bright whites. As such, computer 202 may finely control the lighting effect of each water feature (and the overall effect of the combined display) by addressing a particular LED light fixture 208 and commanding a particular color combination with a twenty-four bit value.

System 200 may also include 2.1 channel sound system 210, which may also be controlled by computer 202. Sound system 210 may include, for example, a right speaker, a left speaker, and a subwoofer associated with fountain system 200. Computer 202 may include audio tracks or may stream or download audio tracks from the Internet that can be broadcast on sound system 210, or computer 202 may cause other devices to play audio tracks on sound system 210, such as external MP3 players, compact disc players, streaming audio players, or the like.

System 200 may thus provide water features, lighting features, and audio features that may be finely controlled by computer 202 to create an overall performance (e.g., water levels and light colors changing in sync to music). Moreover, like system 100 of FIG. 1, system 200 of FIG. 2A may facilitate control of the water features, lighting features, and audio features by a user through a network (not shown). In particular, a user may engage an app on a smartphone or other mobile device to communicate with computer 202 through a network. The user may send commands or requests to computer 202, which may send corresponding control commands to VFD water pumps 206, LED light fixtures 208, and sound system 210. In this manner, fountain system 200 may provide an engaging and interactive experience for users.

FIG. 2B illustrates exemplary control software 220, which may be used, for example, in controller 102 of system 100 or computer 202 of system 200 to, for example, control a water fountain display and facilitate user control through a network connection. Control software 220 may include software application 222, which may include software components corresponding to framework 224, input/output (I/O) data bus 226, network connection 228, and music player 230. In one embodiment, framework 224 may include a set of software classes and interfaces configured to interpret data that comes from network connection 228. Network connection 228 may include any network connection, such as a wired or wireless Internet connection or other network, as well as its associated software. Data coming from network connection 228 to framework 224 may include, for example, a set of command-parameter arrays that may be generated from a user's mobile device and sent through a cloud server to a fountain system. The command-parameter arrays may be interpreted by framework 224 in order to generate control commands for particular fountain components (e.g., commands for VFD water pumps 206, LED light fixtures 208, and sound system 210 of system 200).

Software application 222 may also include software corresponding to I/O data bus 226 for enabling data flow from the computer or controller to various fountain elements. I/O data bus 226 may support a variety of communication protocols over a variety of communication interfaces. For example, an I/O data bus may include a wired or wireless connection to fountain components, such as serial connection RS232, serial connection RS485, Ethernet, universal serial bus (USB), radio frequency transmission, Bluetooth, or the like. I/O data bus 226 may support a variety of protocols along the data bus, such as process field bus (PROFIBUS), MODBUS, MIDI, DMS, DeviceNet, TCP-IP, or the like. Control software 220 with software application 222 may thus facilitate communication between a user and a fountain controller through network connection 228 as well as communication between the fountain controller and fountain elements through I/O data bus 226, with framework 224 interpreting user commands.

Control software 220 with software application 222 may also include music player 230, which may be any music player capable of playing audio tracks. Music player 230 may, for example, play audio tracks as requested by users through network connection 228, and the audio may be broadcast on speakers (e.g., as in sound system 210 of system 200).

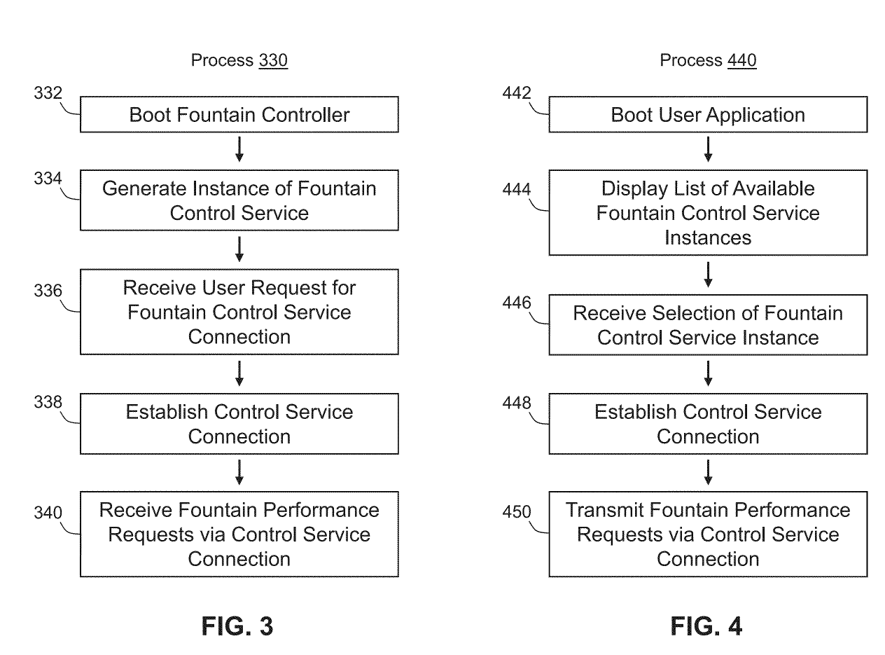

FIG. 3 illustrates exemplary process 330 for establishing user control of a water fountain display through a network. Process 330 may be performed, for example, by controller 102 of system 100 to establish user control from smartphone 118 through network 116 in FIG. 1. Similarly, process 330 may be performed by computer 202 of system 200 to likewise establish user control through a network.

At block 332, the fountain controller may be booted. For example, control software 220 with software application 222 of FIG. 2B may be loaded and booted on a computer or controller. In some examples, a fountain controller may communicate with a central fountain service on a remote server as part of the boot process to obtain updates, download additional software, establish a control connection, or the like.

At block 334, an instance of a fountain control service may be generated. In some examples, a fountain control service may include a particularized software module that facilitates control of a particular fountain or fountain system with its various controllable features. For example, for a fountain with one hundred water features and one hundred lighting features, a corresponding generated fountain control service instance may include the desired addresses, commands, capabilities, and like information to enable control of each of the hundred water features and hundred lighting features. Similarly, a fountain control service corresponding to a fountain system with water features, fog features, and firework features may include the desired address, commands, capabilities, and like information to enable control of each of the water features, fog features, and firework features. A fountain control service instance may thus be customized with the specific controllable capabilities of a particular fountain system.

A fountain control service instance may also be customized with identifying information to enable users to select the appropriate fountain system to control. For example, a fountain control service instance may include an identifying name, location, area, section, display identification, number, or the like, which may uniquely correspond to a particular fountain system or sub-system that may be controlled. A user may select the identifier from a list, input an identifier, input a password, or otherwise select a particular fountain system using the identifying information. In other examples, a particular fountain control service instance may automatically be selected for a user based on proximity, presence on the same network, or the like, and the unique identifier may function within the system to differentiate one fountain system from another fountain system in the same network, city, or the like. In still other examples, user access may be restricted by GPS information collected from a user device (e.g., limiting access to users physically near a fountain as evidenced by GPS information).

At block 336, a user request may be received for a communication channel or fountain control service connection. A user request may include a unique identifier to identify which fountain control service may be desired corresponding to a particular fountain system. A communication channel or fountain control service connection may include a tunnel, peer to peer connection, or the like that allows data transfer between a user's device and the fountain control service.

At block 338, a communication channel or control service connection may be established. Any communication or data transfer mechanism may be used to facilitate data flow between a user's device and a fountain control service. For example, a hypertext transfer protocol (HTTP) tunnel connection may be established that bypasses firewall and TCP-IP port connection settings to facilitate a straightforward and simple connection.

At block 340, fountain performance requests may be received via the communication channel or control service connection. For example, command-parameter arrays may be received from a user's device that correspond to particular fountain performances (e.g., change color, emit water, increase water flow volume, play music, change water flow angle, etc.). In some examples, a handshake or other confirmation may be sent to the user's device to confirm receipt of the performance request. As mentioned with reference to software application 222 of FIG. 2B, fountain performance requests in the form of command-parameter arrays may be interpreted by framework 224 and communicated as commands on I/O data bus 226 to cause fountain elements to execute the requested performance. User control of a fountain system may thus be established according to process 330, although it should be understood that many variations are possible that may similarly establish user control of a fountain system.

FIG. 4 illustrates exemplary process 440 for establishing user control of a water fountain display from a user device through a network. Process 440 may be performed, for example, by a smartphone, tablet computer, mobile device, laptop computer, desktop computer, or the like, under user direction. For example, process 440 may be performed by a processor on smartphone 118 of system 100 to establish user control of fountain components 104 through network 116 in FIG. 1. Similarly, process 440 may be performed by a user's mobile device to establish a connection through a network to computer 202 of system 200 in FIG. 2A in order to control water pumps 206, light fixtures 208, and sound system 210. In some embodiments, an app on a smartphone or other device may include software for carrying out process 440.

At block 442, a user application may be booted on a user's device. A user application may include an app on a smartphone or other mobile device. Booting the application may include accessing the Internet or another network to communicate with a server associated with a fountain system. Booting the application may also include determining the availability of fountain systems that may be controlled using the application (e.g., by querying a server, scanning for fountain control services, etc.).

At block 444, a list of available fountain control service instances may be displayed on a user's device. Available fountain control service instances may be determined by querying a server associated with a fountain system, scanning a network, or the like. In some embodiments, availability may be limited based on other users who may already have established connections with a service instance. In other embodiments, multiple users can connect to the same fountain control service, so a service may be listed even when multiple other users are already connected to the service. Many fountain control service instances may be available, and, in some instances, a narrowed list may be provided based on relevance (e.g., proximity, country, state, city, prior connections, etc.).

At block 446, a selection of a fountain control service instance may be received. In some embodiments, a user may select a fountain control service instance by tapping on the screen, typing in a code, scanning a quick response (QR) code, scanning a bar code, or through any other method.

In other embodiments, a fountain control service instance may be selected in a variety of other ways. For example, after a user application is booted at block 442, a fountain control service instance may automatically be selected by proximity to a fountain system, presence on the same network, user authorization to access a particular fountain system, prior connection to a particular fountain system by a user, or the like.

At block 448, a communication channel or control service connection may be established with the selected fountain control service instance. For example, a user device may communicate with a server, indicate the desired fountain control service instance, and attempt to open a communication channel with the desired fountain control service instance. Any communication or data transfer mechanism may be used to facilitate data flow between a user device and a fountain control service. For example, a hypertext transfer protocol (HTTP) tunnel connection may be established that bypasses firewall and TCP-IP port connection settings to facilitate a straightforward and simple connection. In other embodiments, a communication channel or control service connection may be established by accessing a website, sending a text message, or the like.

At block 450, fountain performance requests may be transmitted via the communication channel or control service connection. For example, command-parameter arrays corresponding to particular fountain performances may be transmitted via the control service connection to the fountain control service instance. Command-parameter arrays may include requests or commands for fountain elements to perform particular functions. For example, requests or commands may include changing lighting colors, emitting water from certain water features, increasing water flow volume for certain water features, playing an audio track, changing the angle of water flow for certain water features, emitting fog from a special effect feature, or any of a variety of other controllable functions for a particular fountain display.

Requests may be generated in a variety of ways from user interaction with a device. For example, a touch sensitive display may facilitate user entry of a request, device sensors may be queried to generate a request based on movement, a device camera may be used to generate a request based on detected objects, a microphone may be used to generate a request based on detected sound, or any of a variety of other device interactions may be used to generate fountain performance requests. A handshake or other confirmation may be received from a server to confirm receipt of a performance request. User control of a fountain display or system through a network may thus be established according to process 440, although it should be understood that many variations are possible that may similarly establish user control of a fountain system.

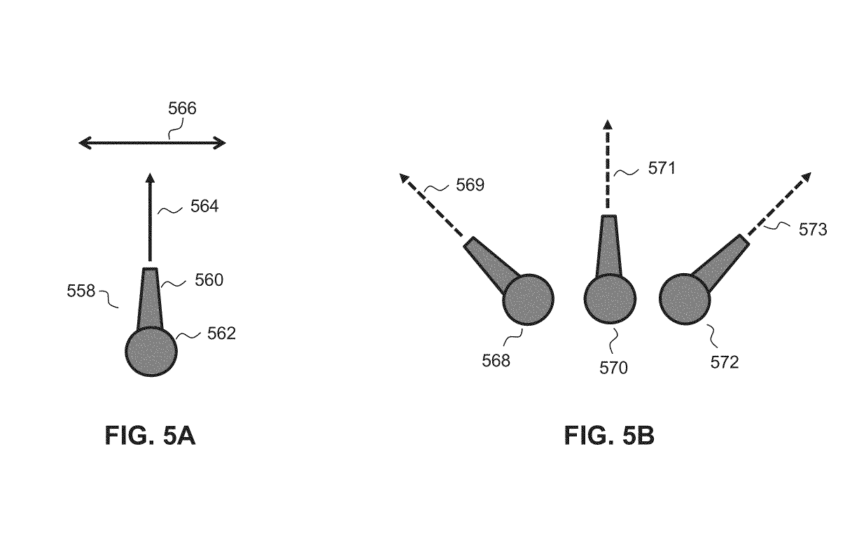

FIG. 5A illustrates exemplary water fountain 558 with direction and flow controls. Fountain 558 may include nozzle 560 that may emit water flow 564. Fountain 558 may also include one or more servomotors (not shown) that may direct nozzle 560 in different directions. For example, a servomotor may be attached to fountain 558 to enable fountain 558 to spin, move, angle, or the like. In one example, fountain 558 may angle from side to side with angular range 566, which may, for example, range sixty degrees in either direction from center. Fountain 558 may also include continuous flow mechanism 562 that may be controlled by a VFD with potentiometer feedback in a closed loop configuration. Continuous flow mechanism 562 may facilitate controlling the emitted volume of water flow 564, which may correspondingly change the height, pressure, width, and other features of the emitted stream.

FIG. 5B illustrates exemplary fountains 568, 570, and 572 in a row with water flows in varied directions. Fountains 568, 570, and 572 may include similar elements as fountain 558 of FIG. 5A, including one or more servomotors allowing for controllable angle, position, spin, and the like. Each of fountains 568, 570, and 572 may be individually controllable. For example, the angle of each fountain may be controlled independently from other fountains, and the volume of water emitted from each fountain may be controlled independently from other fountains. As illustrated, the nozzle of fountain 568 may be angled forty-five degrees left of center such that water is emitted along dashed arrow 569. The nozzle of fountain 570 may be angled straight up in the center such that water is emitted along dashed arrow 571. The nozzle of fountain 572 may be angled forty-five degrees right of center such that water is emitted along dashed arrow 573. It should be appreciated that fountains may include many other features, including a variety of other control elements.

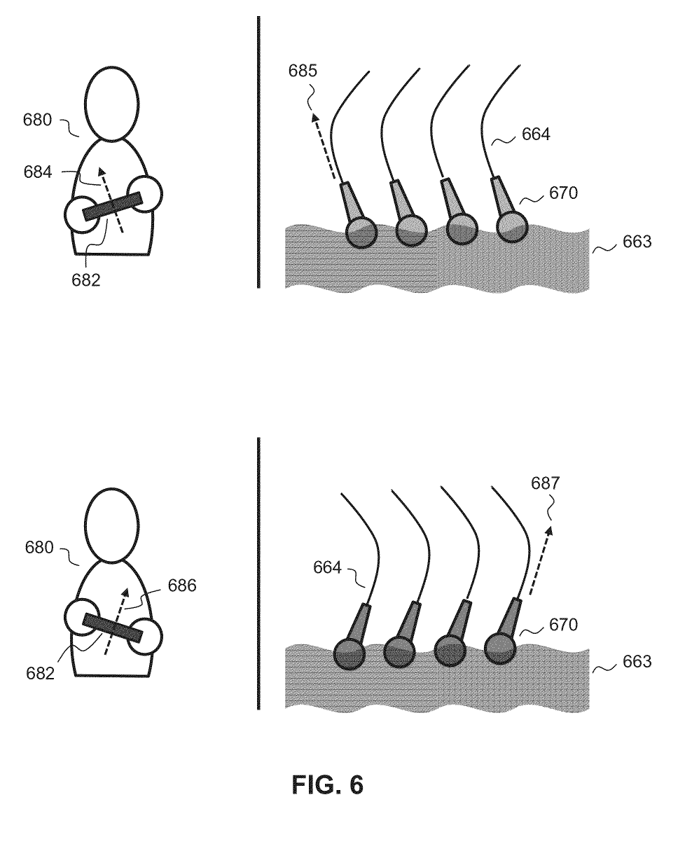

FIG. 6 illustrates exemplary directional control of a series of four fountains 670 in water 663. In one embodiment, user 680 may operate user device 682, which may include a smartphone, tablet computer, handheld controller, or the like. User device 682 may establish a communication channel with a fountain control service according to the processes described herein, such that a communication interface is enabled from user device 682 to a fountain control service instance. The fountain control service instance may correspond to fountains 670 and may enable control of fountains 670 through a network.

In one example, user device 682 may include accelerometers, gyroscopes, or other sensors for detecting movements, angles, and the like of the device. User 680 may select an accelerometer-based fountain control method, such that accelerometer data may be used to generate performance requests that are transmitted to a fountain control service instance. As illustrated, when engaging in such an accelerometer-based control method, user 680 may angle user device 682 as indicated by dashed arrow 684. The accelerometer data may be used to generate a fountain performance request, which may be transmitted to a fountain control service instance. The fountain control service instance may cause commands to be sent to servomotors associated with fountains 670 to cause the nozzles of fountains 670 to angle in order to emit water flows 664 at the angle indicated by dashed arrow 685. The water emission angle indicated by dashed arrow 685 may correspond to the angle of user device 682 indicated by dashed arrow 684.

User 680 may then angle user device 682 as indicated by dashed arrow 686. The new accelerometer data may be used to generate a new fountain performance request, which may cause the nozzles of fountains 670 to be moved such that water flows 664 may be emitted at the new angle indicated by dashed arrow 687. The new water emission angle indicated by dashed arrow 687 may correspond to the new angle of user device 682 indicated by dashed arrow 686. In this manner, water emissions 664 may mimic the angle of user device 682. In some examples, angular changes may be recognized in real time, such that the angle of water emissions 664 may closely follow the angle of user device 682 (e.g., updating the angle every fraction of a second). Sensor data from user device 682 may thus be used for directional control of a fountain. It should be understood that other methods may similarly be used to control the direction of a fountain, including using a touch sensitive display, keyboard, or the like.

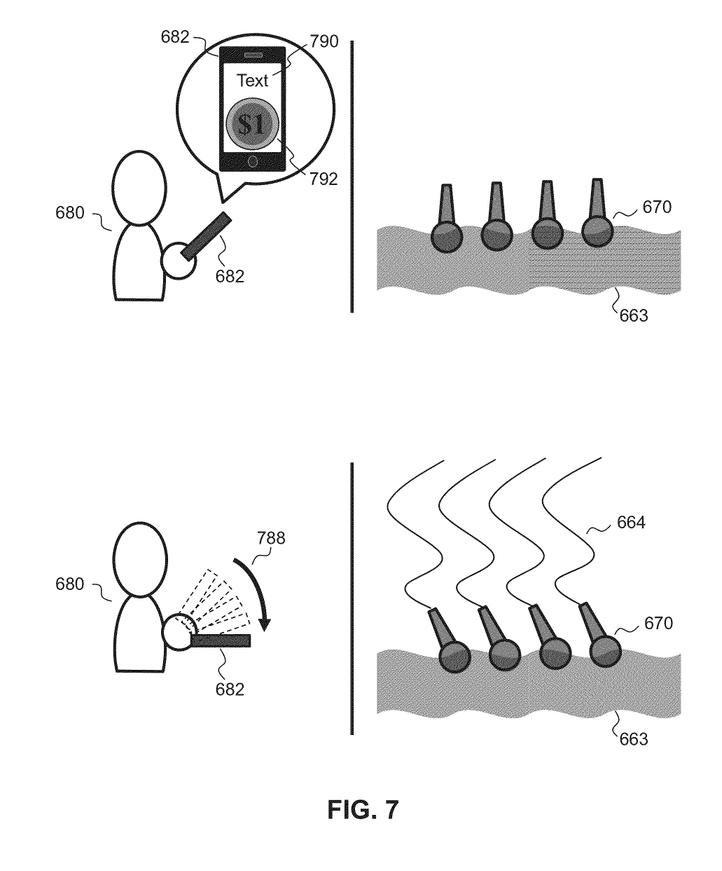

FIG. 7 illustrates an exemplary fountain interaction where the fountain may respond to entered text and gestures. In one embodiment, users may be encouraged to enter text, photos, or other data and interact with a fountain. For example, a fountain may function as a suggestion box, wishing well, community comment board, or the like, where information may be solicited and publicly shared. As illustrated, a user interface on user device 682 may include a textual component 790 where user 680 may enter text, such as a comment, wish, suggestion, or the like. In other examples, users may also enter photos, videos, or other information. The user interface may also include graphic 792, such as a coin (e.g., a coin to be tossed in a wishing well). After entering text 790, user 680 may shake user device 682 or fling user device 682 in the direction indicated by arrow 788 to submit the entered text and virtually toss wishing well coin 792 in water 663. In other embodiments, user 680 may select a submit button on an interface displayed on device 682 or submit the entered information in a different manner. As discussed above, user device 682 may have an established communication channel with a fountain control service instance, and the entered text and recognized gesture may be used to generate a fountain performance request or command. In some embodiments, the entered information may be transmitted to the fountain control service instance.

In response to user 680 entering text 790 and virtually tossing coin 792 with the gesture indicated by arrow 788, various fountain operating characteristics may be changed for fountains 670, such as water emission (on or off), water volume, lighting color, nozzle angle, or the like. For example, fountains 670 may appear to celebrate by emitting water flows 664, which may be angled back and forth in a lively display. From a fountain controller perspective, upon receiving entered text or photos from user 680, the controller may cause various fountain operating characteristics to be changed, such as causing fountains 670 to emit water flows 664 and causing the nozzles of fountains 670 to be angled back and forth to generate a lively display in response to the submission. Many other fountain system performances using various fountain operating characteristics may also be used to respond to a user submission and provide a desired effect (e.g., special effects, movements, sound, etc.).

Entered text 790 (or a photo, video, or other entered information) may be stored or used by a fountain controller in a variety of ways. In one example, entered text 790 may include a wish or comment that may be automatically posted by the fountain controller to a Twitter™ account or Facebook™ account associated with a particular fountain system. In this manner, followers, friends, or other viewers may be engaged by the fountain system whether or not they are physically present at the fountain. In other examples, photos received by a fountain controller may be automatically posted to Twitter™, Facebook™, or a website for display, which may similarly engage viewers with the fountain system, enhancing its attraction and value. For example, a particular fountain system may have an online profile or account on Twitter™, Facebook™, or another Internet site, and the fountain system may automatically post information on its own behalf, including posting its own status, performance schedule, interactivity commentary, user images, user comments, or the like. In addition, a fountain system may also include one or more cameras, video cameras, or other image capture devices, and the system may upload images, slideshows, videos, live video feeds, or the like to Internet sites directly from the system's own image capture devices.

In some examples, information may be posted to a Twitter™ account, Facebook™ account, or other online profile associated with user 680, thereby reaching an audience of the user's followers and friends through social media. An app on user device 682 may, for example, integrate Twitter™ or Facebook™ support, thereby enabling posting of the user's wish, suggestion, photo, video, or the like to the user's account while also transmitting the information to a fountain controller.

In other examples, user-entered information may be collected and reviewed as though the fountain system were a suggestion box, community comment board, or the like. It should be appreciated that there are many other ways in which a fountain system may engage users both near the fountain and through social media and the Internet by receiving information, responding with a fountain performance, and using the received information in a variety of ways.

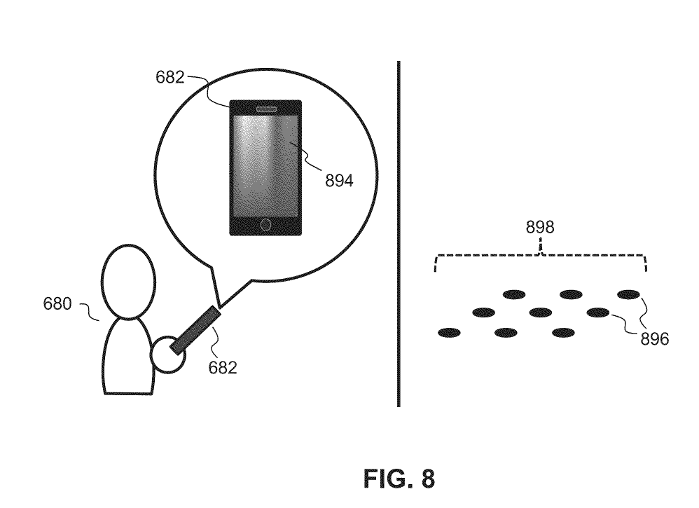

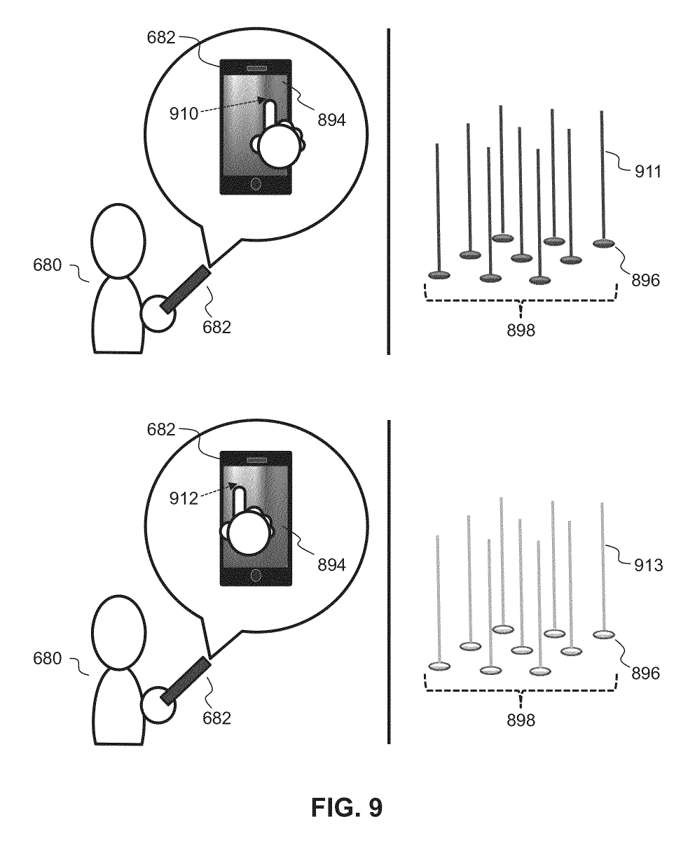

FIG. 8 illustrates exemplary interface 894 for controlling lighting color of splash pad 898. Splash pad 898 may include nine fountains 896 arranged in a rectangular matrix (e.g., a three-by-three matrix as illustrated in FIG. 8). Fountains 896 may include jet type fountains installed such that the nozzle is about even with ground level. In one embodiment, user device 682 may display a color picker interface 894. As discussed above, user device 682 may establish a communication channel or connection with a fountain control service, such that a communication interface is enabled from user device 682 to a fountain control service instance corresponding to splash pad 898. Color picker interface 894 may enable user 680 to control—through a network—on and off functions as well as lighting color changes of fountains 896 in splash pad 898.

Color picker interface 894 may include a color spectrum or color palette ranging from light red hues to dark violet hues. For example, a color spectrum may include red, orange, yellow, green, blue, indigo, and violet, as well as gradations of color in between and darker and lighter hues of all colors. For example, fine gradations of color may allow for over sixteen million color combinations corresponding to a twenty-four bit color data value (eight bits each of red, green, and blue values). User 680 may select a desired color by selecting a point on color picker interface 894 (e.g., by touching a touch sensitive screen, directing a mouse pointer to that region, or the like). In other embodiments, users may enter a desired color in the form of text, such as entering specific red, green, and blue color values. The selected color value may be transmitted to the fountain control service instance corresponding to splash pad 898, which may cause the lighting features of fountains 896 to change to the desired color.

In some embodiments, fountains 896 may be turned off (or valves may be closed to stop emitting water) when a black or very dark color is selected on interface 894. When user 680 later selects a non-black color, fountains 896 may be turned on (or valves may be opened to again emit water), and the lighting features may change to the desired color. Lighting interface 894 and the communication interface discussed herein may allow for near real-time changes of color in splash pad 898. For example, as user 680 moves a finger or pointer across interface 894, lighting features of fountains 896 may update the corresponding light color, including minor changes between very similar colors in the spectrum. In this manner, color picker interface 894 may provide an engaging and entertaining lighting color control experience for user 680

FIG. 9 illustrates exemplary color control of splash pad 898 with user interface 894 discussed above. In one example, user 680 may select color 910 (indicated by a dashed line arrow) on color picker interface 894 by touching the corresponding point on user device 682. The selected color 910 may be transmitted to the fountain control service instance corresponding to splash pad 898. The fountain control service instance may then cause fountains 896 to emit water (or continue to emit water if already on) and the corresponding lighting features to emit light of color 911 corresponding to selected color 910. For example, selected color 910 may include a blue-violet color, and emitted light color 911 from fountains 896 may correspondingly include the same blue-violet color.

In another example, user 680 may select color 912 (indicated by a dashed line arrow) on color picker interface 894 by touching the corresponding point on user device 682. The new selected color 912 may be transmitted to the fountain control service instance corresponding to splash pad 898, which may cause fountains 896 to continue to emit water and the corresponding lighting features to change to emit light of new color 913 corresponding to new selected color 912. For example, new selected color 912 may include a yellow-green color, and emitted light color 913 from fountains 896 may correspondingly include the same yellow-green color. In another example, user 680 may drag a finger from color 910 to new color 912, and lighting features of fountains 896 may emit light of gradually changing colors between color 910 and color 912 as the user's finger traces over the different color points on color picker interface 894. Color picker interface 894 may thus be used for controlling fountain lighting color. It should be understood that other methods may similarly be used to control fountain lighting, including controlling additional lighting features (e.g., strobe, on/off, etc.) with buttons or the like.

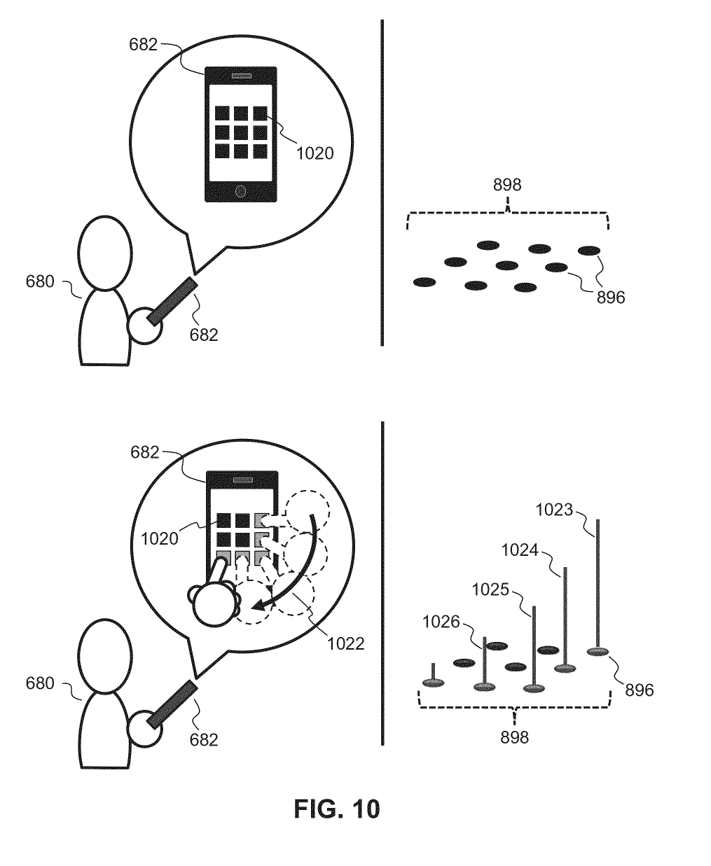

FIG. 10 illustrates exemplary interface 1020 for controlling individual fountains 896 in splash pad 898. In one embodiment, fountain control interface 1020 may include buttons or blocks corresponding to fountains 896 in splash pad 898. For example, interface 1020 may include a three-by-three matrix of blocks corresponding to the three-by-three arrangement of fountains 896 in splash pad 898. The lower left block in interface 1020 may correspond to the lower left fountain in splash pad 898, the upper right block in interface 1020 may correspond to the upper right fountain in splash pad 898, and so on.

When a block is selected in interface 1020, the selection may be transmitted to a fountain control service instance corresponding to splash pad 898, as discussed herein. The fountain control service instance may then cause the corresponding fountain 896 to turn on or the corresponding valve to be opened such that water is emitted from that fountain. For example, as user 680 drags a finger from the upper right block in interface 1020 around the edge down to the lower left block in interface 1020 as indicated by arrow 1022, the corresponding fountains may emit water. In some examples, water emission may gradually increase to its full potential over a short amount of time. FIG. 10 may illustrate a snapshot in time shortly after user 680 has traced a finger according to arrow 1022. As the first selected fountain, emitted water 1023 may be the highest or have the most volume, followed by emitted water 1024, 1025, 1026, and so on. After a brief amount of time, all selected fountains may reach full water volume and have water emitted at the same, full level. Selecting a block in interface 1020 again may cause the corresponding fountain to turn off or the corresponding valve to close, thereby allowing user 680 to individually control the on and off functions of fountains 896.

In some embodiments, selecting a block in interface 1020 may also cause lighting features corresponding to the selected fountain to turn on and emit light. When a block is selected in interface 1020, water may be emitted and the corresponding lighting feature may be turned on. The color of the light may be selected using an interface like interface 894 described above with regard to FIG. 8 and FIG. 9. For example, user 680 may switch to interface 1020 from interface 894, and the last selected color in interface 894 may be the light color emitted when a block is selected in interface 1020 and the corresponding lighting feature is turned on.

In other embodiments, a color palette may be used in other ways to control fountains 896. For example, a color palette like interface 894 may be used to select a desired color. When a user selects a block in interface 1020, the block may change to the color selected from the color palette, the corresponding fountain may be turned on (if not already), and the corresponding lighting feature may emit light of the selected color. To turn off a selected jet, user 680 may select a black or dark hue from the color palette and assign that color to the desired blocks in interface 1020. When selected with a black color, a block in interface 1020 may change to black, the corresponding fountain may be turned off, and the corresponding lighting feature may likewise be turned off. In this manner, user 680 may individually control water emission, light emission, and light color for fountains 896. It should be appreciated that many other methods are possible for enabling users to individually control fountains and corresponding lighting features.

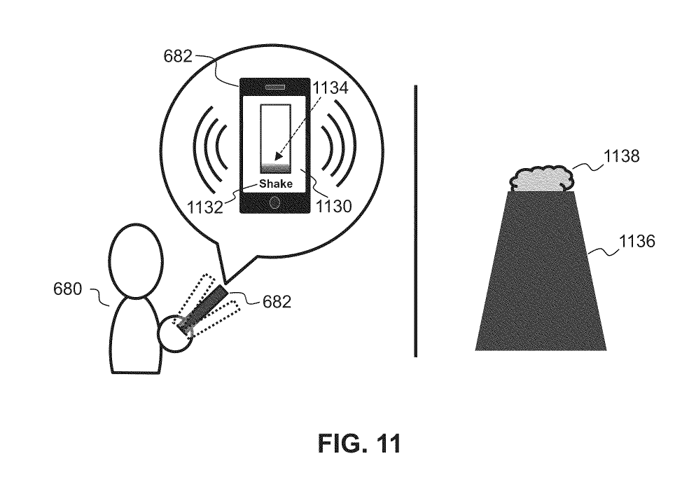

FIG. 11 illustrates exemplary interface 1130 for facilitating interaction with fountain 1136 based on movement of user device 682. In one embodiment, fountain 1136 may include a volcano-like structure where water may be emitted from the top of the volcano as though erupting (it should be understood, however, that the described fountain interaction may be implemented in any of a variety of other fountains). Interface 1130 may include textual direction 1132 instructing user 680 to perform a particular action to cause the fountain to respond in a particular way. For example, as illustrated, textual direction 1132 may instruct user 680 to shake user device 682. Interface 1130 may also include indicator 1134, which may depict the relative power, energy, or accuracy of the user's performance. As discussed herein, user device 682 may transmit the relative power, energy, or accuracy of the user's performance to a fountain control service instance corresponding to fountain 1136. The fountain control service instance may then cause water emission 1138 from fountain 1136 to correspond in volume or power to the relative power, energy, or accuracy indicated by indicator 1134.

In other examples, interface 1130 may display other instructions and indicate performance, energy, or accuracy in other ways. Similarly, interface 1130 may display instructions visually instead of or in addition to textual description 1132. Fountain 1136 may also respond in a variety of ways to information received about user performance.

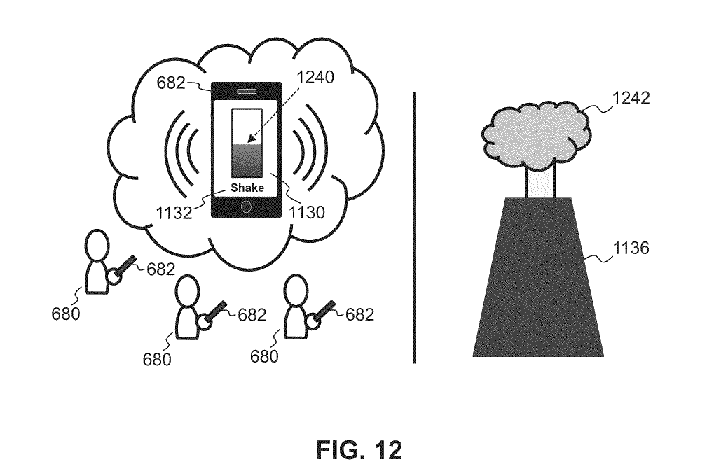

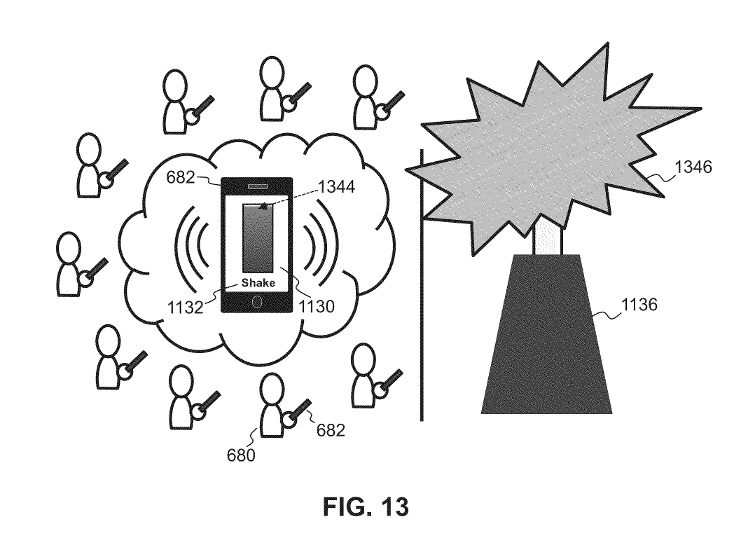

FIG. 12 illustrates an exemplary fountain interaction where fountain 1136 may respond to movements of a small group of user devices 682. In one embodiment, volcano fountain 1136 may respond with a large eruption of water when multiple users combine together to produce a large amount of shaking energy as measured by user devices 682. Each of user devices 682 may be in communication with a fountain control service instance corresponding to fountain 1136, such that information may be received by the control service instance for multiple users at the same time. For example, three users 680 may all engage in the activity indicated by interface 1130 on their devices 682—here, shaking the devices. The cumulative shaking energy of the three users 680 may be reflected by indicator 1240. As illustrated, three users 680 may produce a certain amount of energy, and the fountain control service instance may cause fountain 1136 to emit water emission 1242 at a level corresponding to the level indicated by indicator 1240. In this manner, a group of users 680 may be engaged together in a fountain interaction.

FIG. 13 illustrates an exemplary fountain interaction where fountain 1136 may respond to movements of a large group of user devices 682. As mentioned above, volcano fountain 1136 may respond with a large eruption of water when multiple users combine together to produce a large amount of shaking energy as measured by user devices 682. Each of user devices 682 may be in communication with a fountain control service instance corresponding to fountain 1136, such that information may be received by the control service instance for multiple users at the same time. In the example illustrated in FIG. 13, nine users 680 may all engage in the shaking activity indicated by interface 1130 on their devices 682. The cumulative shaking energy of the nine users 680 may be reflected by indicator 1344. As illustrated, nine users 680 may produce a certain amount of energy, and the fountain control service instance may cause fountain 1136 to emit water emission 1346 at a level corresponding to the level indicated by indicator 1344. In this example, nine users 680 shaking their devices 682 may be sufficient to reach the relative maximum of energy as indicated by indicator 1344, and water emission 1346 may correspondingly be a maximum water eruption.

In any of the examples of FIG. 11, FIG. 12, and FIG. 13, a formula may be used for translating user device movement into a water emission level. For example, cumulative shaking energy from multiple users on multiple devices may be defined as follows:

$${E}_{v} = {\sum }_{i}^{n} {E}_{ui}$$

Eᵥ may be the cumulative shaking energy of user devices for the volcano, Eᵤᵢ may be the shaking energy of each individual user, and n may be the number of users. The individual shaking energy may be measured by a user device, such as a smartphone with accelerometers, gyroscopes, or other movement sensors. For example, the energy of an individual user device may be defined as follows:

Eᵤ=∫₀^{t}(kf(t)+lf_{y}(t)+mf_{z}(f))dt

Eᵤ may be the shaking energy of a single user, t may be time, and k, l, and m may be balancing constants that may modulate the result though time of x, y, and z functions that may represent accelerometer output in time from a user device.

A fountain control service instance may sum the energy from multiple users to determine the corresponding volcano fountain output. For example, if the summed energy Eᵥ equals zero, the volcano water emission output may be a minimum value (e.g., ten percent). Over time, if the summed energy remains low or zero, an attenuation factor may be applied to the volcano water emission to gradually reduce the emission to zero without user participation. If the summed energy Eᵥ is greater than zero but less than a designated trigger level, the volcano water emission output may be a moderate value (e.g., ten to thirty percent). For example, the summed energy may be mapped to a corresponding volcano water emission output over a certain range. Low energy totals near zero may correspond to a volcano water emission of ten percent, high energy totals near a designated trigger level may correspond to a volcano water emission of thirty percent, and energy totals in between may be mapped between ten and thirty percent emission (e.g., linearly, exponentially, etc.). If the summed energy Eᵥ is greater than or equal to the designated trigger level, the volcano water emission output may be a maximum eruption value (e.g., one hundred percent), as illustrated in FIG. 13 with nine users participating. Multiple users may thus interact with a fountain together to achieve different fountain responses, which may further engage users and enhance the value of the fountain.

Multiple fountain interactions may thus be achieved by facilitating communication between a user device and a fountain control service instance through a network. While various examples have been illustrated and described, many others are contemplated that may incorporate the novel teachings of this disclosure. For example, users may be able to design their own fountain show or sequence including various fountain features (e.g., music, lighting features, water features, etc.). Users may then communicate with a fountain control service instance to upload their design, and the fountain control service instance may cause the sequence or show to be performed. Users may also interact with a fountain control service in a variety of other ways to obtain a variety of other fountain performances.

Moreover, the novel teachings of this disclosure are not limited to fountain applications and may be applied to a variety of other areas. For example, users may engage mobile devices to communicate through a network and interact with television screens, motors, lights, or other devices in parks, shopping malls, public squares, or other spaces. Users may, for example, control a light display in a park, change a television display in a shopping mall, or control moving art in a public square through a network using a mobile device as described herein for controlling fountain performances. Facebook™, Twitter™, and other online functions may similarly be integrated into these other systems.

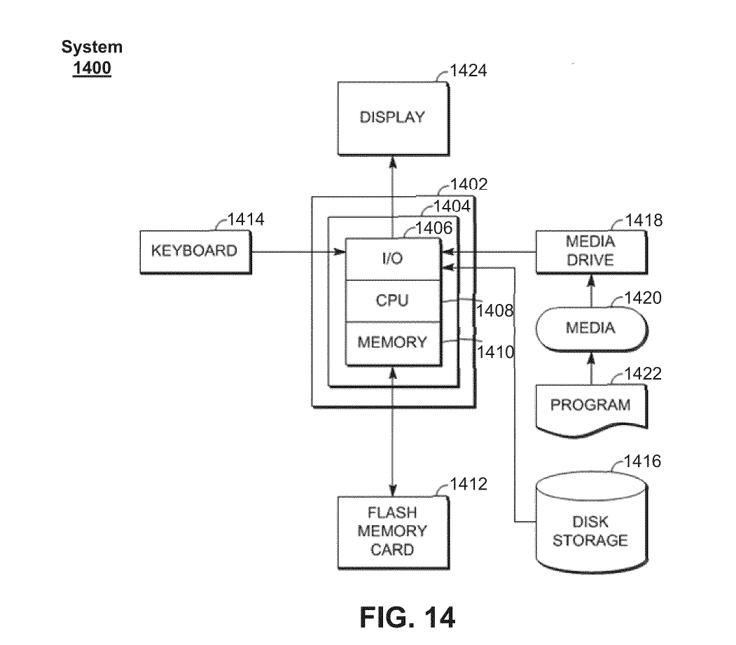

FIG. 14 depicts an exemplary computing system 1400 configured to perform any one of the above-described processes. In this context, computing system 1400 may include, for example, a processor, memory, storage, and input/output devices (e.g., monitor, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 14 depicts computing system 1400 with a number of components that may be used to perform the above-described processes. The main system 1402 includes a motherboard 1404 having an input/output (“I/O”) section 1406, one or more central processing units (“CPU”) 1408, and a memory section 1410, which may have a flash memory card 1412 related to it. The I/O section 1406 is connected to a display 1424, a keyboard 1414, a disk storage unit 1416, and a media drive unit 1418. The media drive unit 1418 can read/write a computer-readable medium 1420, which can contain programs 1422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

What is claimed is:

1. A computer-implemented method for facilitating control of a fountain system through a network, the method comprising:
receiving, via the network from a user device, a request for a communication channel for sending fountain performance requests;
receiving a request for a fountain hardware performance from the user device through the communication channel; and
causing the fountain hardware to perform the requested performance;
wherein the fountain hardware comprises one or more water fountains.

2. The computer-implemented method of claim 1, wherein the fountain hardware performance request comprises a selection of an angle of the one or more water fountains.

3. The computer-implemented method of claim 2, wherein the user device generates accelerometer data based on movement; and
wherein the selection of the angle of the one or more water fountains is derived from accelerometer data of the user device.

4. The computer-implemented method of claim 2, wherein causing the fountain hardware to perform the requested performance comprises causing a motor to angle the one or more water fountains according to the selected angle.

5. The computer-implemented method of claim 1, wherein the fountain hardware performance request comprises a textual entry from the user device.

6. The computer-implemented method of claim 5, wherein causing the fountain hardware to perform the requested performance comprises causing a fountain operating characteristic to be changed; and
wherein the fountain operating characteristic comprises one or more of water emission, water volume, lighting color, or nozzle angle.

7. The computer-implemented method of claim 5, further comprising:
causing the textual entry to be uploaded to a website.

8. The computer-implemented method of claim 1, wherein the fountain hardware performance request comprises a selection of a lighting color.

9. The computer-implemented method of claim 8, wherein causing the fountain hardware to perform the requested performance comprises causing a lighting feature to emit colored light corresponding to the selection.

10. The computer-implemented method of claim 1, wherein the fountain hardware performance request comprises a measure of movement of the user device.

11. The computer-implemented method of claim 10, wherein causing the fountain hardware to perform the requested performance comprises causing the one or more water fountains to emit water at a level corresponding to the measure of movement of the user device.

12. A fountain system comprising:
fountain hardware comprising one or more water fountains; and
a processor communicatively coupled to a network, wherein the processor is configured to:
receive, via the network from a user device, a request for a communication channel for sending fountain performance requests;
receive a request for a fountain hardware performance from the user device through the communication channel; and
cause the fountain hardware to perform the requested performance.

13. The fountain system of claim 12, wherein the fountain hardware performance request comprises a selection of an angle of the one or more water fountains.

14. The fountain system of claim 13, wherein the user device generates accelerometer data based on movement; and
wherein the selection of the angle of the one or more water fountains is derived from accelerometer data of the user device.

15. The fountain system of claim 12, wherein the fountain hardware performance request comprises a textual entry from the user device.

16. The fountain system of claim 15, wherein causing the fountain hardware to perform the requested performance comprises causing a fountain operating characteristic to be changed; and
wherein the fountain operating characteristic comprises one or more of water emission, water volume, lighting color, or nozzle angle.

17. The fountain system of claim 15, the processor further configured to:
cause the textual entry to be uploaded to a website.

18. The fountain system of claim 12, wherein the fountain hardware performance request comprises a selection of a lighting color; and
wherein causing the fountain hardware to perform the requested performance comprises causing a lighting feature to emit colored light corresponding to the selection.

19. The fountain system of claim 12, wherein the fountain hardware performance request comprises a measure of movement of the user device; and
wherein causing the fountain hardware to perform the requested performance comprises causing the one or more water fountains to emit water at a level corresponding to the measure of movement of the user device.

20. A non-transitory computer-readable storage medium comprising computer-executable instructions for facilitating control of a fountain system through a network, the instructions comprising:
receiving, via the network from a user device, a request for a communication channel for sending fountain performance requests;
receiving a request for a fountain hardware performance from the user device through the communication channel; and
causing the fountain hardware to perform the requested performance;
wherein the fountain hardware comprises one or more water fountains.
